(19) United States
(12) Patent Application Publication
(10) Pub. No.: US 2018/0285929 A1
(43) Pub. Date: Oct. 4, 2018

(54) PROVIDING SPONSORED CONTENT ITEMS IN CONJUNCTION WITH A PRESENTATION OF A MEDIA CONTENT ITEM

(71) Applicant: Google Inc., Mountain View, CA (US)

(72) Inventors: Justin Lewis, Marina del Rey, CA (US); Ruxandra Georgiana Paun, Santa Monica, CA (US)

(21) Appl. No.: 14/621,014

(22) Filed: Feb. 12, 2015

Related U.S. Application Data
(60) Provisional application No. 61/939,254, filed on Feb. 12, 2014.

(51) Int. Cl. G06Q 30/02; G06F 3/0484

(52) U.S. Cl. CPC G06Q 30/0257; G06F 3/04842

(57) ABSTRACT

Systems and methods are disclosed for providing sponsored content items in conjunction with a presentation of a media content item. In one implementation, a processing device receives a selection of a media content item, the media content item being provided within a content presentation interface, identifies a first sponsored content item with respect to a content presentation slot within the content presentation interface, provides, based on the selection of the media content item, the first sponsored content item within the content presentation slot, identifies a second sponsored content item with respect to the content presentation slot, and, based on a determination that the media content item is not viewable within the content presentation interface, provides the second sponsored content item within the content presentation slot.

### CROSS-REFERENCE TO RELATED APPLICATION

This application is related to and claims the benefit of U.S. Patent Application No. 61/939,254, filed Feb. 12, 2014, the entirety of which is incorporated herein by reference.

### TECHNICAL FIELD

Aspects and implementations of the present disclosure relate to data processing, and more specifically, to providing sponsored content items in conjunction with a presentation of a media content item.

### BACKGROUND

Audio and video content can be stored on data servers and provided to users for listening/viewing over the Internet. Applications for supporting the listening/viewing of such audio and video content may be browser-based, or may run independently of a browser.

### SUMMARY

The following presents a simplified summary of various aspects of this disclosure in order to provide a basic understanding of such aspects. This summary is not an extensive overview of all contemplated aspects, and is intended to neither identify key or critical elements nor delineate the scope of such aspects. Its purpose is to present some concepts of this disclosure in a simplified form as a prelude to the more detailed description that is presented later.

In an aspect of the present disclosure, a processing device receives a selection of a media content item, the media content item being provided within a content presentation interface. The processing device identifies a first sponsored content item with respect to a content presentation slot within the content presentation interface. The processing device provides, based on the selection of the media content item, the first sponsored content item within the content presentation slot. The processing device identifies a second sponsored content item with respect to the content presentation slot. The processing device provides, based on a determination that the media content item is not viewable within the content presentation interface, the second sponsored content item within the content presentation slot.

In another aspect, a processing device receives a selection of a media content item, the media content item being provided within a content presentation interface. The processing device provides, based on the selection of the media content item, a first sponsored content item within a content presentation slot arranged within the content presentation interface. After a user completes viewing the media content item in the content presentation interface, the processing device provides a second sponsored content item within the content presentation slot.

### BRIEF DESCRIPTION OF THE DRAWINGS

Aspects and implementations of the present disclosure will be understood more fully from the detailed description given below and from the accompanying drawings of various aspects and implementations of the disclosure, which, however, should not be taken to limit the disclosure to the specific aspects or implementations, but are for explanation and understanding only.

FIG. 1 depicts an illustrative system architecture, in accordance with one implementation of the present disclosure.

FIG. 2A depicts a flow diagram of aspects of a method for providing sponsored content items in conjunction with a presentation of a media content item.

FIG. 2B depicts a flow diagram of aspects of a method for providing sponsored content items in conjunction with a presentation of a media content item.

FIG. 3 depicts an exemplary content presentation interface, in accordance with one implementation of the present disclosure.

FIG. 4 depicts an exemplary content presentation interface, in accordance with one implementation of the present disclosure.

FIG. 5 depicts an exemplary content presentation interface, in accordance with one implementation of the present disclosure.

FIG. 6 depicts a block diagram of an illustrative computer system operating in accordance with aspects and implementations of the present disclosure.

### DETAILED DESCRIPTION

Aspects and implementations of the present disclosure are directed to providing sponsored content items in conjunction with a presentation of a media content item. The systems and methods disclosed can be applied to media content such as audio and/or video content, images, and/or any other content that can be collected and/or disseminated such as via a media sharing service or website. More particularly, many media sharing services and social networking services provide sponsored content items (e.g., advertisements) in conjunction with other content such as user generated content (e.g., media content items such as videos, music, etc., provided by content creators). Such sponsored content items (e.g., display ads, banner ads, etc.) can be provided in designated sections or regions of a user interface which can be referred to as ad slots.

Additionally, such media sharing services and social networking services can provide various interfaces in which content originating from various users/content providers can be aggregated and presented/viewed, such as in a ‘feed’ or content ‘stream.’ Accordingly, scenarios can arise in which a particular interface (e.g., of a social networking feed) may present one (or more) sponsored content items (e.g., advertisements) as well as several content items (e.g., embedded videos) each of which may be associated with a different content creator/provider. In such a scenario, it can be difficult to attribute the revenue generated by the provided sponsored content item to any particular content creator/provider, since the same sponsored content item can often be provided throughout the presentation of multiple content items (e.g., in a scenario in which a user watches several videos from the content ‘feed’).

Accordingly, described herein in various embodiments are technologies that enable providing sponsored content items in conjunction with a presentation of a media content item. For example, upon receiving a selection of a media content item (e.g., a video embedded within a social network ‘feed’), a first sponsored content item can be selected and provided in conjunction with the media content item. Upon determining that the selected media content item is no longer viewable, another sponsored content item can be selected and provided in lieu of the first sponsored content item. In doing so, the presentation of a particular sponsored content item (e.g., the first sponsored content item) can be appropriately attributed to the media content item (e.g., to the creator of the media content item), such as is described herein.

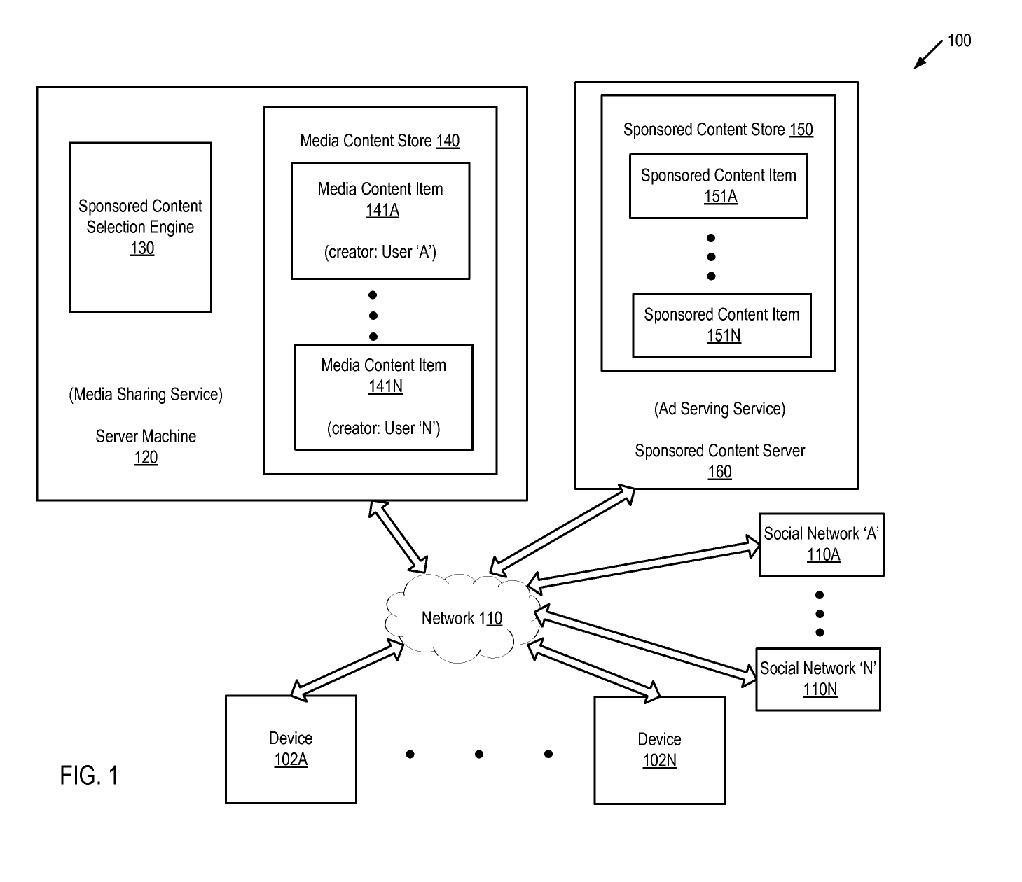

FIG. 1 depicts an illustrative system architecture 100, in accordance with one implementation of the present disclosure. The system architecture 100 includes user devices 102A-102N, social networking services 110A-110N, server machine 120, and sponsored content server 160. These various elements or components can be connected to one another via network 110, which can be a public network (e.g., the Internet), a private network (e.g., a local area network (LAN) or wide area network (WAN)), or a combination thereof.

User devices 102A-102N can be wireless terminals (e.g., smartphones, etc.), personal computers (PC), laptops, tablet computers, or any other computing or communication devices. The user devices 102A-102N may run an operating system (OS) that manages hardware and software of the user devices 102A-102N. Various applications, such as mobile applications (‘apps’), web browsers, etc. (not shown) may run on the client machines (e.g., on the OS of the client machines). Such applications can, for example, enable a user to capture media content (e.g., an audio clip, a video clip, etc.), provide media content (e.g., upload media content to a central server and/or transmit it to another user), receive media content (e.g., via network 110), and/or view, display, or otherwise present media content (e.g., playing a video, listening to a song, etc.), such as via the user device 102. The user devices 102A-102N can be geographically distributed anywhere throughout the world.

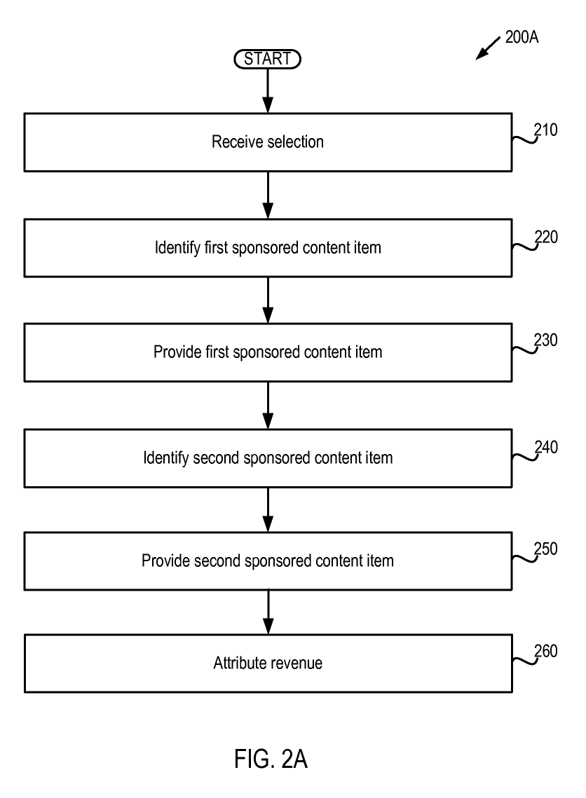

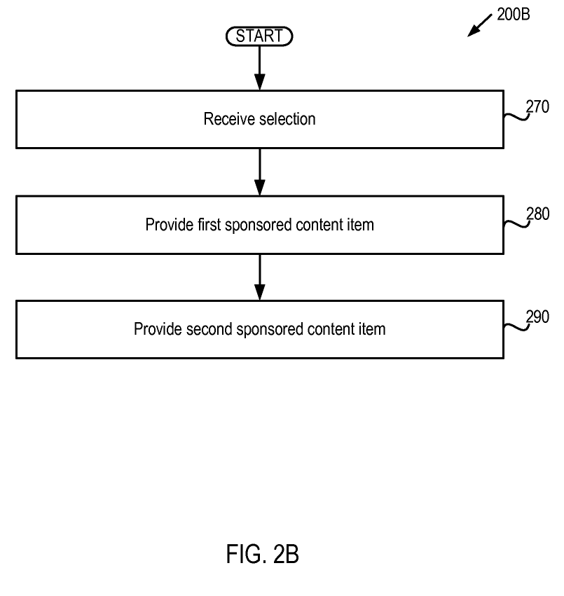

Server machine 120 can be a rackmount server, a router computer, a personal computer, a portable digital assistant, a mobile phone, a laptop computer, a tablet computer, a camera, a video camera, a netbook, a desktop computer, a media center, any combination of the above, or any other such computing device capable of implementing the various features described herein. Server machine 120 can include components such as sponsored content selection engine 130, and media content store 140. The components can be combined together or separated in further components, according to a particular implementation. It should be noted that in some implementations, various components of server machine 120 may run on separate machines. Moreover, some operations of certain of the components are described in more detail below with respect to FIGS. 2A and 2B.

Media content store 140 can be hosted by one or more storage devices, such as main memory, magnetic or optical storage based disks, tapes or hard drives, NAS, SAN, and so forth. In some implementations, media content store 140 can be a network-attached file server, while in other implementations media content store 140 can be some other type of persistent storage such as an object-oriented database, a relational database, and so forth, that may be hosted by the server machine 120 or one or more different machines coupled to the server machine 120 via the network 110, while in yet other implementations media content store 140 may be a database that is hosted by another entity and made accessible to server machine 120.

Media content store 140 can include media content items 141A-141N. In certain implementations, media content items 141A-141N can correspond to media content itself (e.g., audio clips, video clips, images, etc.) and can be provided, for example, by a media content provider. Moreover, in certain implementations, server machine 120 can be configured to allow viewers wishing to access or view such media content items to do so via one or more webpages and/or applications provided by the media sharing service and/or via one or more embedded media viewers that can be incorporated within other webpages and/or applications.

Media content store 140 can be hosted by one or more storage devices, such as main memory, magnetic or optical storage based disks, tapes or hard drives, NAS, SAN, and so forth. In some implementations, media content store 140 can be a network-attached file server, while in other implementations media content store 140 can be some other type of persistent storage such as an object-oriented database, a relational database, and so forth, that may be hosted by the server machine 120 or one or more different machines coupled to the server machine 120 via the network 110, while in yet other implementations media content store 140 may be a database that is hosted by another entity and made accessible to server machine 120.

Sponsored content server 160 can be a rackmount server, a router computer, a personal computer, a portable digital assistant, a mobile phone, a laptop computer, a tablet computer, a camera, a video camera, a netbook, a desktop computer, a media center, any combination of the above, or any other such computing device capable of implementing the various features described herein. Sponsored content server 160 can include components such as sponsored content store 150. The components can be combined together or separated in further components, according to a particular implementation. It should be noted that in some implementations, various components of sponsored content server 160 may run on separate machines.

In certain implementations, sponsored content server 160 can be an advertisement serving system/service. Such an ad service system/service can receive requests for sponsored content from various content publishers, such as media sharing service 120 (e.g., a video sharing site) and/or social networks 110. In response to requests from such content publishers, the ad serving system can provide various sponsored content items 151 (e.g., ads) for presentation within websites, applications, interfaces, etc., provided by such content publishers (e.g., to one or more users, such as via devices 102). In certain implementations, various content sponsors (e.g., advertisers) can provide compensation and/or other incentives to the ad serving service (e.g., on a per impression, per click, per conversion, etc. basis) in return for the ad serving service serving such ads to the various content publishers. In doing so, such content publishers can monetize their respective services (e.g., media sharing, social networking, etc.). Moreover, as described herein, in certain implementations such content publishers can elect to share a portion of the revenue generated by the presentation of such sponsored content with various content creators that provide content (e.g., media content items) via the services provided by such content publishers (e.g., media sharing services, social networks, etc.). In doing so, a content publisher can further incentivize content creators to create and disseminate content (e.g., media content items) via a particular service (e.g., the media sharing service, social network, etc.).

Sponsored content store 150 can include sponsored content items 151A-151N. In certain implementations, sponsored content items 151A-151N can correspond to sponsored content (e.g., audio, video, images, display ads, banner ads, video ads, audio ads, interactive ads, etc.) provided by one or more third parties, such as advertisers. As noted, such advertisers provide compensation and/or other incentives to content publishers (e.g., media sharing sites, social networking sites, etc.) in return for such publishers providing sponsored content items 151 to users of a site or service of the publisher.

It should be understood that though FIG. 1 depicts server machine 120, sponsored content server 160, social networks 110, and devices 102 as being discrete components, in various implementations any number of such components (and/or elements/functions thereof) can be combined, such as within a single component/system. For example, in certain implementations server machine 120 can incorporate features of the sponsored content server, while in other implementations one or more of social networks 110 can incorporate features of the sponsored content server.

Social networks 110A-110N can be one or more servers, computers, devices, etc., that provide a framework for social networking services, such as those that enable users to communicate and/or share information with one another. In certain implementations, each social network can provide a website and/or an application that enables users to utilize the functionality provided by the social network. Moreover, in certain implementations various social networks can enable users to share or otherwise disseminate media content items to other users, such as by providing one or more links to such media content items within posts, pages, and/or any other such interfaces provided by the social network, and/or by embedding such media content items within such posts, pages, and/or interfaces. Additionally, as described, in certain implementations such social networks can provide various sponsored content items (e.g., advertisements) within various interfaces, such as in order to generate revenue for the social networking service and/or to provide content that is relevant/of interest to users of the social networking service.

As described herein, upon receiving a selection of a media content item (e.g., a video embedded within a social network ‘feed’), a first sponsored content item can be selected and provided in conjunction with the media content item. Upon determining that the selected media content item is no longer viewable, another sponsored content item can be selected and provided in lieu of the first sponsored content item. In certain implementations, such operations can be performed by and/or in conjunction with sponsored content selection engine 130. In doing so, the presentation of a particular sponsored content item (e.g., the first sponsored content item) can be appropriately attributed to the media content item (e.g., to the creator of the media content item), such as is described herein.

At this juncture it should be noted that while various aspects of the technologies described herein are illustrated with respect to a social networking service (e.g., with respect to media content items and/or sponsored content items that are embedded and/or otherwise provided within a social networking service), such implementations are exemplary. Accordingly, it should be understood that, in other implementations, the various technologies described herein can be employed with respect to a media sharing service (e.g., with respect to media content items and/or sponsored content items that are provided within a media sharing service).

FIG. 2A depicts a flow diagram of aspects of a method 200A for providing sponsored content items in conjunction with a presentation of a media content item. The method is performed by processing logic that may comprise hardware (circuitry, dedicated logic, etc.), software (such as is run on a general purpose computer system or a dedicated machine), or a combination of both. In one implementation, the method is performed by server machine 120 of FIG. 1, while in some other implementations, one or more blocks of FIG. 2A may be performed by another machine. For example, in various alternative implementations, the method can be performed at a social network 110 and/or a user device 102 (i.e., the method or various aspects thereof can be performed locally at the social network 110 and/or device 102 rather than in communication with a server such as server machine 120).

For simplicity of explanation, methods are depicted and described as a series of acts. However, acts in accordance with this disclosure can occur in various orders and/or concurrently, and with other acts not presented and described herein. Furthermore, not all illustrated acts may be required to implement the methods in accordance with the disclosed subject matter. In addition, those skilled in the art will understand and appreciate that the methods could alternatively be represented as a series of interrelated states via a state diagram or events. Additionally, it should be appreciated that the methods disclosed in this specification are capable of being stored on an article of manufacture to facilitate transporting and transferring such methods to computing devices. The term article of manufacture, as used herein, is intended to encompass a computer program accessible from any computer-readable device or storage media.

At block 210, a selection of a media content item can be received. In certain implementations, such a media content item 141 can be provided and/or otherwise presented within a content presentation interface. Such a content presentation interface can be, for example, a webpage, mobile application, and/or any other such presentation interface or context within which content (e.g., text, media, etc.) can be presented/arranged. Moreover, in certain implementations, the referenced selection can be a selection to play a media content item on a user device. Alternatively, the media content item can be selected via a social network user interface and this selection can be communicated to the server 120. In one aspect, block 210 is performed by sponsored content selection engine 130.

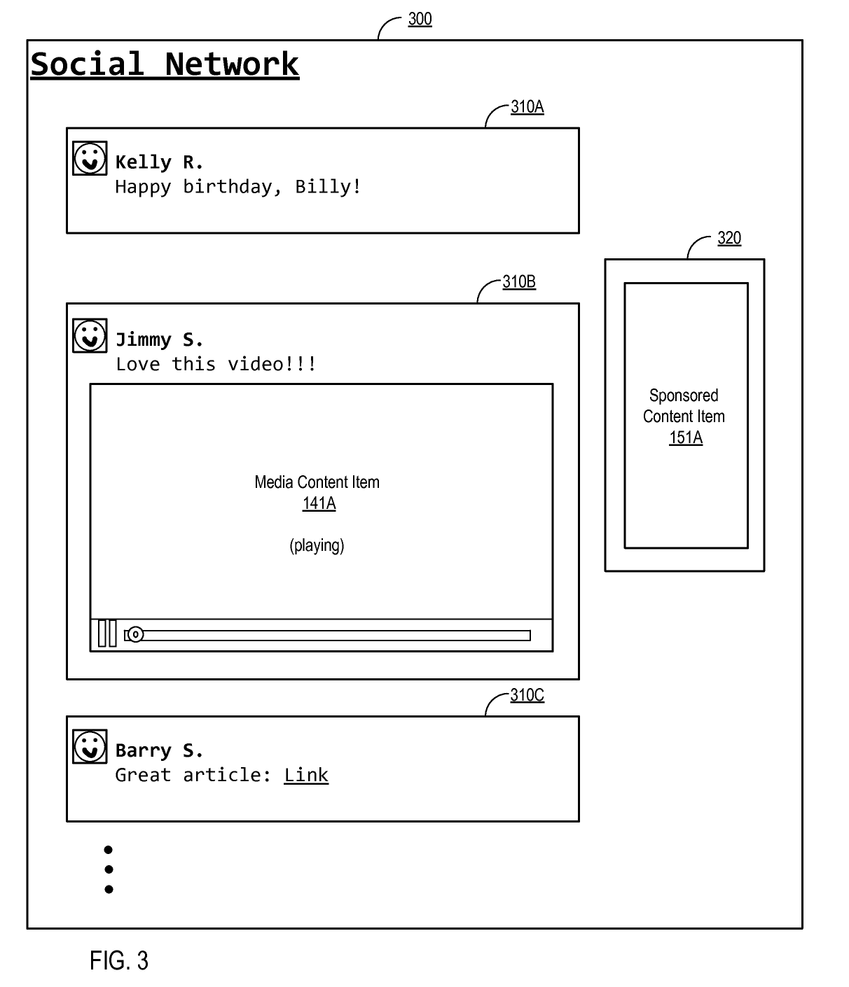

For example, as shown in FIG. 3, content presentation interface 300 of a social networking site or service (‘Social Network’) can include various posts or messages 310A, 310B, 310C. Such posts/messages 310 can incorporate elements including but not limited to media content item(s) (e.g., post 310B within which media content item 141A is embedded). It should be understood that, in various implementations, various posts/messages (e.g., those originating from different users) can be aggregated and/or otherwise provided together, such as in a ‘feed’ or content ‘stream.’

At block 220, a first sponsored content item can be identified. In certain implementations, such a sponsored content item (e.g., an advertisement) can be selected with respect to a content presentation slot, such as a content presentation slot within a content presentation interface (e.g., the content presentation interface within which the media content item selected at block 210 is present). In certain implementations, the referenced sponsored content item can be selected based on one or more aspects of a media content item (e.g., the media content item selected at block 210). For example, FIG. 3 depicts content presentation slot 320 which can be a dedicated region of interface 300 within which sponsored content 151 (e.g., advertisements) can be provided. As noted, the particular sponsored content item to be presented within content presentation slot 320 (e.g., sponsored content item 151A, as shown in FIG. 3) can be selected based on one or more aspects of a media content item, such as the subject matter, category, etc., of the media content item (such that a sponsored content item that may be complimentary to the media content item and/or otherwise of potential relevance/interest to a user viewing the media content item can be selected). In one aspect, block 220 is performed by sponsored content selection engine 130. Alternatively, the sponsored content item can be selected by sponsored content server 160 from a set of sponsored content items and provided to the server 120 or the social network 110 (or served to the user device in response to instructions from the server 120 or the social network 110). For example, sponsored content items such as ads can be auctioned to determine what ads should be returned to the server 120 and/or the order in which they should be presented to the user. This determination may depend on, for example, other advertisers' bids (e.g., the maximum amount an advertiser will pay per user click on an advertisement) and/or the performance scores of the ads. The performance score of an ad may be calculated based on, for example, historical click-through rates, relevance of an advertiser's ad text and keywords, an advertiser's account history, etc. In another implementation, the ads are selected by the sponsored content server 160 on a reservation basis (e.g., based on predefined conditions) without taking into account other advertisers' bids and/or the performance scores of the ads.

Moreover, in certain implementations the referenced sponsored content item can be selected based on one or more aspects of a sponsored media content item presented in conjunction with the media content item (e.g., the media content item selected at block 210). That is, it can be appreciated that, upon receiving a selection of a media content item (e.g., an instruction to initiate/play the media content item), one or more sponsored content items (e.g., sponsored videos, etc.) can be presented, e.g., prior to the presentation of the selected media content item itself. Accordingly, in a scenario in which such a sponsored media content item is presented/played prior to the selected media content item itself, a sponsored content item can be selected (e.g., for presentation in content presentation slot 320) based on/in conjunction with the sponsored media content item. For example, in certain implementations, a sponsored content item that complements the sponsored media content item (e.g., in that both are directed to a similar demographic but do not pertain to competing products, etc.) can be selected. By way of further example, in certain implementations a sponsored content item that pertains to the sponsored media content item (e.g., in that both are associated with the same content sponsor and/or are directed to the same product, service, etc.) can be selected.

At block 230, the first sponsored content item (e.g., as selected at block 220) can be provided. In certain implementations, such a sponsored content item can be presented within a content presentation slot (e.g., a content presentation slot present within the content presentation interface within which the media content item selected at block 210 is present). Such a content presentation slot (e.g., content presentation slot 320 of FIG. 3) can be a fixed and/or dynamic section or region of a webpage, application interface, etc., within which sponsored content items can be provided. In one aspect, block 230 is performed by sponsored content selection engine 130.

Moreover, in certain implementations such a sponsored content item can be provided based on the selection of a media content item (e.g., the selection received at block 210). That is, upon receiving a selection (e.g., an instruction/command to activate/play the media content item), the selected sponsored content item can be provided within the referenced content presentation slot. For example, in the scenario depicted in FIG. 3, prior to initiating, activating, and/or playing media content item 141A, content presentation slot 320 may include another sponsored content item and/or no sponsored content item. Upon receiving a selection of media content item 141A (e.g., at block 210), sponsored content item 151A can be selected (e.g., at block 220) and/or provided within the content presentation slot, such as is described herein.

It should be understood that, in certain implementations, the referenced media content item (e.g., media content item 141A as depicted in FIG. 3) and the content presentation slot (e.g., content presentation slot 320) are viewable within a viewable region of the content presentation interface (e.g., interface 300). That is, in certain implementations, multiple content presentation slots can be arranged within a content presentation interface. It can be appreciated that while some of the referenced content presentation slots may be visible within a viewable region of the content presentation interface (e.g., a segment or section of the content presentation interface that is presently viewable on a screen of a device) while the referenced media content item is also viewable within the content presentation interface, other content presentation slots may be visible only by navigating (e.g., scrolling) the content presentation interface to another segment/section (e.g., a segment/section within which the referenced media content item is not also viewable). Accordingly, in various implementations the technologies described herein can be configured to associate a media content item to those content presentation slots that are also viewable within the same viewable region of the content presentation interface. In doing so, various presentations of sponsored content items can be appropriately attributed to the media content item (e.g., to the creator of the media content item), such as is described herein.

At block 240, a second sponsored content item can be identified. In certain implementations, such a sponsored content item can be selected with respect to a content presentation slot (e.g., a content presentation slot present within the content presentation interface within which the media content item selected at block 210 is present). In one aspect, block 240 is performed by sponsored content selection engine 130. Alternatively, the second sponsored content item can be selected by sponsored content server 160 from a set of sponsored content items and provided to the server 120 or the social network 110 (or served to the user device in response to instructions from the server 120 or the social network 110).

At block 250, the second sponsored content item (e.g., as selected at block 240) can be provided. In certain implementations such a sponsored content item can be presented within a content presentation slot (e.g., the content presentation slot within which the first sponsored content item was provided, such as at block 230). Moreover, in certain implementations the second sponsored media content item can be provided (e.g., within the referenced content presentation slot) based on a determination that a media content item (e.g., the media content item selected at block 210) is not viewable within the content presentation interface (e.g., the content presentation interface within which the media content item selected at block 210 is present). In one aspect, block 250 is performed by sponsored content selection engine 130.

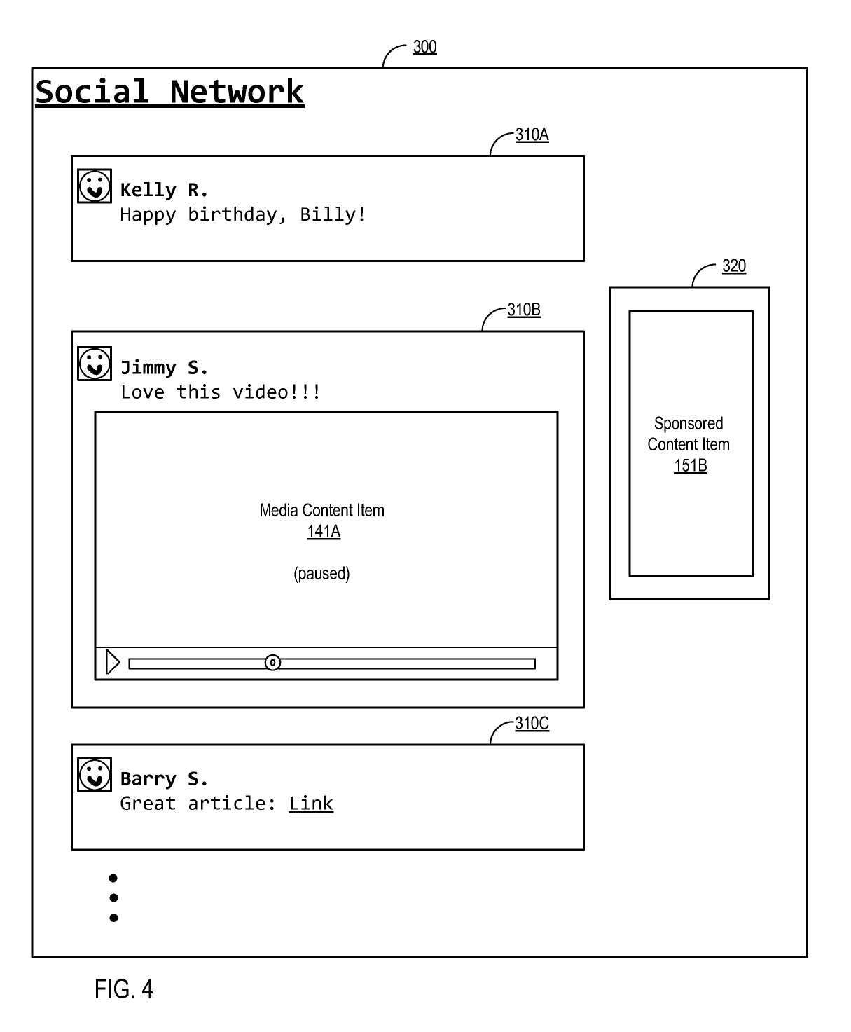

For example, FIG. 4, depicts a scenario substantially comparable to that depicted in FIG. 3, though in which media content item 141A has been paused (and is thus not presently viewable/being viewed within content presentation interface 300). Accordingly, though content presentation slot 320 may include sponsored content item 151A while media content item 141A is playing (e.g., as depicted in FIG. 3), upon determining that the media content item is no longer viewable (e.g., by receiving a ‘pause’ command), another sponsored content item 151B can be selected (e.g., at block 240) and/or provided within the content presentation slot, such as is described herein. In doing so (e.g., in transitioning from one sponsored content item, e.g., sponsored content item 151A, to another sponsored content item, e.g., sponsored content item 151B, upon determining that the media content item is no longer viewable), the presentation of a particular sponsored content item (e.g., sponsored content item 151A) can be appropriately attributed to the media content item (e.g., to the creator of the media content item), such as is described herein.

Moreover, in certain implementations, such a sponsored content item (e.g., a second sponsored content item) can be provided (e.g., within a content presentation slot such as the content presentation slot within which the first sponsored content item was provided, such as at block 230) based on a determination that a presentation of a media content item (e.g., the media content item selected at block 210) has concluded. For example, in a scenario such as that depicted in FIG. 3, content presentation slot 320 may include sponsored content item 151A while media content item 141A is playing, however, upon determining that the media content item has concluded/stopped (e.g., at the end of the duration of the media content item), another sponsored content item 151B can be selected (e.g., at block 240) and/or provided within the content presentation slot, such as is described herein. In doing so (e.g., in transitioning from one sponsored content item, e.g., sponsored content item 151A, to another sponsored content item, e.g., sponsored content item 151B, upon determining that a presentation of a media content item has concluded), the presentation of a particular sponsored content item (e.g., sponsored content item 151A) can be appropriately attributed to the media content item (e.g., to the creator of the media content item), such as is described herein.

Additionally, in certain implementations, such a sponsored content item (e.g., a second sponsored content item) can be provided (e.g., within a content presentation slot such as the content presentation slot within which the first sponsored content item was provided, such as at block 230) based on a determination that a media content item (e.g., the media content item selected at block 210) is not viewable within a viewable region of a content presentation interface (e.g., the content presentation interface within which the media content item selected at block 210 is present). In doing so (e.g., in transitioning from one sponsored content item, e.g., sponsored content item 151A, to another sponsored content item, e.g., sponsored content item 151B, upon determining that a media content item is no longer viewable within a viewable region of a content presentation interface), the presentation of a particular sponsored content item (e.g., sponsored content item 151A) can be appropriately attributed to the media content item (e.g., to the creator of the media content item), such as is described herein.

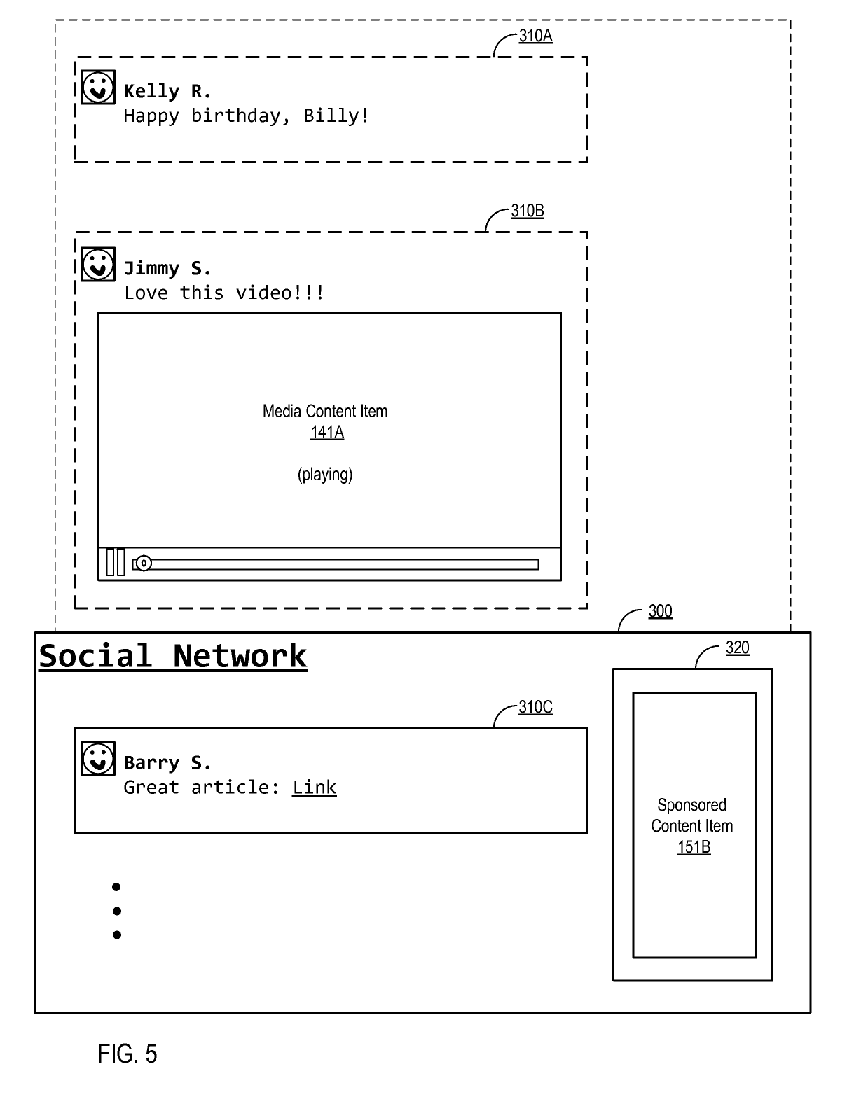

For example, FIG. 5, depicts a scenario substantially comparable to that depicted in FIG. 3, though in which a user has scrolled or otherwise navigated within content presentation interface 300 such that media content item 141A, even if still playing, is no longer viewable within a viewable region of the content presentation interface (it should be understood with reference to FIG. 5 that the dashed lines represent elements of the content presentation interface that are not presently viewable, e.g., within a screen of a device, such as on account of a user scrolling down the page/interface). Accordingly, though content presentation slot 320 may include sponsored content item 151A while media content item 141A is playing and is also within a viewable region of the content presentation interface (e.g., as depicted in FIG. 3), upon determining that the media content item is no longer viewable within a viewable region of a content presentation interface (e.g., as depicted in FIG. 5, such as on account of a user scrolling, navigating, etc., the page), another sponsored content item 151B can be selected (e.g., at block 240) and/or provided within the content presentation slot, such as is described herein.

At block 260, revenue generated with respect to a sponsored content item (e.g., the first sponsored content item, such as the sponsored content item provided at block 230) can be attributed. In certain implementations, such revenue can be attributed to a content creator (e.g., a creator and/or owner of one or more media content items) associated with the media content item (e.g., the media content item selected at block 210). In one example, server 120 can receive an indication from the user device that a user has viewed the sponsored content item while the media content item was presented, and can store this information to either provide it to the advertiser or bill the advertiser and pay the creator and/or owner of the media content item. It can also be appreciated that third parties such as advertisers may provide compensation and/or other incentives to content publishers such as social networks, etc., in exchange for presenting sponsored content items to users/viewers of the social networks. Accordingly, being that the display of a particular sponsored content item (e.g., sponsored content item 151A, as depicted in FIG. 3) can be associated with the presentation of a particular media content item (e.g., media content item 141A, such as on account of the fact that sponsored content item 151A is presented when the media content item is initiated/activated, and is replaced when the media content item is stopped, etc., such as is depicted in FIGS. 4 and 5), the revenue generated by the presentation of the sponsored content item (e.g., as may be paid by/received from an advertiser) can be attributed to the creator/owner, etc., of the media content item (e.g., User ‘A,’ as depicted in FIG. 1). In doing so, the content publisher (e.g., the provider of content presentation interface 300, such as a social network) can, in turn, provide some or all of the accrued revenue to the content creator/owner. In one aspect, block 260 is performed by sponsored content selection engine 130.

FIG. 2B depicts a flow diagram of aspects of a method 200B for providing sponsored content items in conjunction with a presentation of a media content item. The method is performed by processing logic that may comprise hardware (circuitry, dedicated logic, etc.), software (such as is run on a general purpose computer system or a dedicated machine), or a combination of both. In one implementation, the method is performed by one or more of social networks 110 of FIG. 1, while in some other implementations, one or more blocks of FIG. 2B may be performed by one or more other machine(s).

For simplicity of explanation, methods are depicted and described as a series of acts. However, acts in accordance with this disclosure can occur in various orders and/or concurrently, and with other acts not presented and described herein. Furthermore, not all illustrated acts may be required to implement the methods in accordance with the disclosed subject matter. In addition, those skilled in the art will understand and appreciate that the methods could alternatively be represented as a series of interrelated states via a state diagram or events. Additionally, it should be appreciated that the methods disclosed in this specification are capable of being stored on an article of manufacture to facilitate transporting and transferring such methods to computing devices. The term article of manufacture, as used herein, is intended to encompass a computer program accessible from any computer-readable device or storage media.

At block 270, a selection (e.g., of a media content item) can be received. In certain implementations, such a media content item can be provided within a content presentation interface. For example, a media content item 141 (e.g., originating at media content store 140 of server machine 120) can be provided (e.g., embedded) within a content presentation interface (e.g., a webpage, mobile application, etc.) provided by a social networking service (e.g., Social Network ‘A’ 110A). It should be understood that, in certain implementations, the referenced selection can be a selection to play the media content item (e.g., as presented within a content ‘feed’ provided by the social networking service). In one aspect, block 270 is performed by sponsored content selection engine 130 (which, though not shown in FIG. 1, can execute at/in relation to a social network).

At block 280, a first sponsored content item can be provided. In certain implementations, such a sponsored content item can be requested from and/or provided by an ad serving service such as sponsored content server 160 (it should be understood that, in various implementations, a social network can request sponsored content items from sponsored content server 160). Moreover, in certain implementations, such a sponsored content item can be requested and/or provided (e.g., by the social networking service) based on the selection of the media content item (e.g., at block 270). Moreover, in certain implementations, such a sponsored content item can be provided within a content presentation slot, such as a content presentation slot arranged within a content presentation interface (e.g., the content presentation interface of the social networking service within which the selected media content item is also presented). For example, upon receiving a selection (e.g., an instruction/command to activate/play the media content item embedded within the content presentation interface of the social networking service), a sponsored content item (e.g., originating from sponsored content server 160) can be provided within a content presentation slot of the same content presentation interface. In one aspect, block 280 is performed by sponsored content selection engine 130 (which, though not shown in FIG. 1, can execute at/in relation to a social network).

At block 290, a second sponsored content item can be provided. In certain implementations, such a sponsored content item can be requested from and/or provided by an ad serving service such as sponsored content server 160. Moreover, in certain implementations, such a sponsored content item can be requested and/or provided (e.g., by the social networking service) based on a determination that the media content item (e.g., the media content item selected at block 270) is not viewable, such as within a content presentation interface of the social networking service. Moreover, in certain implementations, such a sponsored content item can be provided within a content presentation slot, such as a content presentation slot arranged within the content presentation interface.

For example, upon determining that a media content item (e.g., the media content item embedded within a content presentation interface of a social networking service and selected at block 270) has been paused, stopped, etc. (and is thus not presently viewable/being viewed within the content presentation interface of the social networking service), another sponsored content item can be requested from and/or provided by an ad serving service such as sponsored content server 160. Moreover, in certain implementations, such a sponsored content item (e.g., a second sponsored content item) can be provided within a content presentation slot, such as a content presentation slot arranged within a content presentation interface (e.g., the content presentation interface of the social networking service). In doing so (e.g., in transitioning from one sponsored content item to another sponsored content item upon determining that the media content item is no longer viewable within the content presentation interface of the social networking service), the presentation of a particular sponsored content item (e.g., as embedded within the social networking service) can be appropriately attributed to the media content item (e.g., to the creator of the media content item), such as is described herein.

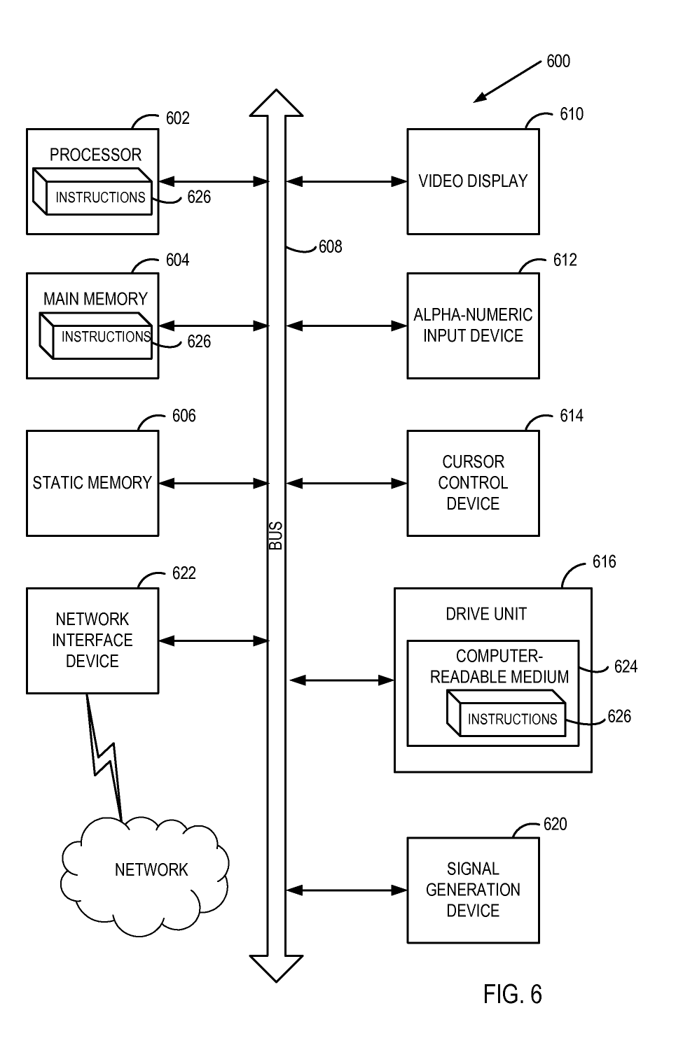

FIG. 6 depicts an illustrative computer system within which a set of instructions, for causing the machine to perform any one or more of the methodologies discussed herein, may be executed. In alternative implementations, the machine may be connected (e.g., networked) to other machines in a LAN, an intranet, an extranet, or the Internet. The machine may operate in the capacity of a server machine in client-server network environment. The machine may be a personal computer (PC), a set-top box (STB), a server, a network router, switch or bridge, or any machine capable of executing a set of instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein.

The exemplary computer system 600 includes a processing system (processor) 602, a main memory 604 (e.g., read-only memory (ROM), flash memory, dynamic random access memory (DRAM) such as synchronous DRAM (SDRAM)), a static memory 606 (e.g., flash memory, static random access memory (SRAM)), and a data storage device 616, which communicate with each other via a bus 608.

Processor 602 represents one or more general-purpose processing devices such as a microprocessor, central processing unit, or the like. More particularly, the processor 602 may be a complex instruction set computing (CISC) microprocessor, reduced instruction set computing (RISC) microprocessor, very long instruction word (VLIW) microprocessor, or a processor implementing other instruction sets or processors implementing a combination of instruction sets. The processor 602 may also be one or more special-purpose processing devices such as an application specific integrated circuit (ASIC), a field programmable gate array (FPGA), a digital signal processor (DSP), network processor, or the like. The processor 602 is configured to execute instructions 626 for performing the operations and steps discussed herein.

The computer system 600 may further include a network interface device 622. The computer system 600 also may include a video display unit 610 (e.g., a liquid crystal display (LCD) or a cathode ray tube (CRT)), an alphanumeric input device 612 (e.g., a keyboard), a cursor control device 614 (e.g., a mouse), and a signal generation device 620 (e.g., a speaker).

The data storage device 616 may include a computer-readable medium 624 on which is stored one or more sets of instructions 626 (e.g., instructions executed by collaboration manager 225, etc.) embodying any one or more of the methodologies or functions described herein. Instructions 626 may also reside, completely or at least partially, within the main memory 604 and/or within the processor 602 during execution thereof by the computer system 600, the main memory 604 and the processor 602 also constituting computer-readable media. Instructions 626 may further be transmitted or received over a network via the network interface device 622.

While the computer-readable storage medium 624 is shown in an exemplary embodiment to be a single medium, the term “computer-readable storage medium” should be taken to include a single medium or multiple media (e.g., a centralized or distributed database, and/or associated caches and servers) that store the one or more sets of instructions. The term “computer-readable storage medium” shall also be taken to include any medium that is capable of storing, encoding or carrying a set of instructions for execution by the machine and that cause the machine to perform any one or more of the methodologies of the present disclosure. The term “computer-readable storage medium” shall accordingly be taken to include, but not be limited to, solid-state memories, optical media, and magnetic media.

In the above description, numerous details are set forth. It will be apparent, however, to one of ordinary skill in the art having the benefit of this disclosure, that embodiments may be practiced without these specific details. In some instances, well-known structures and devices are shown in block diagram form, rather than in detail, in order to avoid obscuring the description.

Some portions of the detailed description are presented in terms of algorithms and symbolic representations of operations on data bits within a computer memory. These algorithmic descriptions and representations are the means used by those skilled in the data processing arts to most effectively convey the substance of their work to others skilled in the art. An algorithm is here, and generally, conceived to be a self-consistent sequence of steps leading to a desired result. The steps are those requiring physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise as apparent from the above discussion, it is appreciated that throughout the description, discussions utilizing terms such as “receiving,” “processing,” “providing,” “identifying,” or the like, refer to the actions and processes of a computer system, or similar electronic computing device, that manipulates and transforms data represented as physical (e.g., electronic) quantities within the computer system's registers and memories into other data similarly represented as physical quantities within the computer system memories or registers or other such information storage, transmission or display devices.

Aspects and implementations of the disclosure also relate to an apparatus for performing the operations herein. This apparatus may be specially constructed for the required purposes, or it may comprise a general purpose computer selectively activated or reconfigured by a computer program stored in the computer. Such a computer program may be stored in a computer readable storage medium, such as, but not limited to, any type of disk including floppy disks, optical disks, CD-ROMs, and magnetic-optical disks, read-only memories (ROMs), random access memories (RAMs), EPROMs, EEPROMs, magnetic or optical cards, or any type of media suitable for storing electronic instructions.

The algorithms and displays presented herein are not inherently related to any particular computer or other apparatus. Various general purpose systems may be used with programs in accordance with the teachings herein, or it may prove convenient to construct a more specialized apparatus to perform the required method steps. The required structure for a variety of these systems will appear from the description below. In addition, the present disclosure is not described with reference to any particular programming language. It will be appreciated that a variety of programming languages may be used to implement the teachings of the disclosure as described herein.

It is to be understood that the above description is intended to be illustrative, and not restrictive. Many other embodiments will be apparent to those of skill in the art upon reading and understanding the above description. Moreover, the techniques described above could be applied to other types of data instead of, or in addition to, media clips (e.g., images, audio clips, textual documents, web pages, etc.). The scope of the disclosure should, therefore, be determined with reference to the appended claims, along with the full scope of equivalents to which such claims are entitled.

1. A method comprising:
providing a feed on a user device, the feed comprising videos for presentation;
receiving a selection of a first video in the feed, wherein the selection is to initiate a playback of the first video;
identifying, by a processing device, a first sponsored content item with respect to a content presentation slot within the feed;
providing, based on the selection of the first video, the first sponsored content item for presentation within the content presentation slot with the first video;
identifying a second sponsored content item with respect to the content presentation slot;
based on a determination that the first video is no longer viewable within the feed, providing the second sponsored content item for presentation within the content presentation slot in lieu of the first sponsored content item; and
attributing a presentation of the first sponsored content item to the first video in the feed, wherein the presentation of the first sponsored content item is attributed to the first video in the feed regardless of other videos in the feed.

2. (canceled)

3. The method of claim 1, wherein selecting the first sponsored content item comprises selecting the first sponsored content item based on one or more aspects of the first video.

4. The method of claim 1, wherein selecting the first sponsored content item comprises selecting the first sponsored content item based on one or more aspects of the first sponsored content item presented in conjunction with the first video.

5. The method of claim 1, wherein providing the second sponsored content item comprises based on a determination that a presentation of the first video has concluded, providing the second sponsored content item within the content presentation slot.

6. The method of claim 1, wherein providing the second sponsored content item comprises based on a determination that the first video is no longer viewable within a viewable region of the feed, providing the second sponsored content item within the feed.

7. The method of claim 1, wherein the first video and the content presentation slot are viewable within a viewable region of the feed.

8. The method of claim 1, wherein attributing a presentation of the first sponsored content item to the first video in the feed further comprises attributing revenue generated with respect to the first sponsored content item to a content creator associated with the first video.

9. A system comprising:
a memory; and
a processing device, coupled to the memory, to:
provide a feed, the feed comprising videos for presentation;
receive a selection of a first video in the feed,
wherein the selection is to initiate a playback of the first video;
identify a first sponsored content item with respect to a content presentation slot within the feed;
provide, based on the selection of the first video, the first sponsored content item for presentation within the content presentation slot with the first video;
identify a second sponsored content item with respect to the content presentation slot;
based on a determination that the first video is no longer viewable within the feed, provide the second sponsored content item for presentation within the content presentation slot in lieu of the first sponsored content item; and
attribute a presentation of the first sponsored content item to the first video in the feed, wherein the presentation of the first sponsored content item is attributed to the first video in the feed regardless of other videos in the feed.

10. (canceled)

11. The system of claim 9, wherein to select the first sponsored content item comprises selecting the first sponsored content item based on one or more aspects of the first video.

12. The system of claim 9, wherein to select the first sponsored content item comprises selecting the first sponsored content item based on one or more aspects of the first sponsored content item presented in conjunction with the first video.

13. The system of claim 9, wherein to provide the second sponsored content item is to provide, based on a determination that a presentation of the first video has concluded, the second sponsored content item within the content presentation slot.

14. The system of claim 9, wherein to provide the second sponsored content item is to provide, based on a determination that the first video is no longer viewable within a viewable region of the feed, the second sponsored content item within the content presentation slot.

15. The system of claim 9, wherein the first video and the content presentation slot are viewable within a viewable region of the feed.

16. The system of claim 9, wherein to attribute a presentation of the first sponsored content item to the first video in the feed, the processing device is further to attribute revenue generated with respect to the first sponsored content item to a content creator associated with the first video.

17. A computer readable medium having instructions stored thereon that, when executed by a processor, cause the processor to perform operations comprising:
providing a feed on a user device, the feed comprising videos for presentation;
receiving a selection of a first video in the feed, wherein the selection is to initiate a playback of the first video;
identifying, by a processing device, a first sponsored content item with respect to a content presentation slot within the feed;
providing, based on the selection of the first video, the first sponsored content item for presentation within the content presentation slot with the first video;
identifying a second sponsored content item with respect to the content presentation slot;
based on a determination that the first video is no longer viewable within the feed, providing the second sponsored content item for presentation within the content presentation slot in lieu of the first sponsored content item; and
attributing a presentation of the first sponsored content item to the first video in the feed, wherein the presentation of the first sponsored content item is attributed to the first video in the feed regardless of other videos in the feed.

18. The computer readable medium of claim 17, wherein providing the second sponsored content item comprises based on a determination that a presentation of the first video has concluded, providing the second sponsored content item within the content presentation slot.

19. The computer readable medium of claim 17, wherein providing the second sponsored content item comprises based on a determination that the first video is no longer viewable within a viewable region of the feed, providing the second sponsored content item within the content presentation slot

20. A method comprising:
providing a feed on a user device, the feed comprising videos for presentation;
receiving a selection of a first video in the feed, wherein the selection is to initiate a playback of the first video;
providing, based on the selection of the first video, a first sponsored content item with the first video, the first sponsored content item within a content presentation slot arranged within the feed;
after a user completes viewing the first video in the feed, providing, by a processing device, a second sponsored content item within the content presentation slot in lieu of the first sponsored content item; and
attributing a presentation of the first sponsored content item to the first video in the feed, wherein the presentation of the first sponsored content item is attributed to the first video in the feed regardless of other videos in the feed.
